(19) United States
(12) Patent Application Publication
(10) Pub. No.: US 2018/0089309 A1
(43) Pub. Date: Mar. 29, 2018

(54) TERM SET EXPANSION USING TEXTUAL SEGMENTS

(71) Applicant: Linkedln Corporation, Mountain View, CA (US)

(72) Inventor: GANESH VENKATARAMAN, SAN JOSE, CA (US)

(21) Appl. No.: 15/278,832

(22) Filed: Sep. 28, 2016

(51) Int. Cl. G06F 17/30

(52) U.S. Cl. CPC G06F 17/30684; G06F 17/30713

(57) ABSTRACT

This disclosure relates to systems and methods for increasing member engagement at an online social network. In one example, a method includes receiving user input that includes an incomplete sequence of terms, retrieving two or more suggestions to expand the sequence of terms, converting, for each of the suggestions, the sequence of terms to a respective sequence of segments using the suggestion, scoring the suggestions according to a frequency of how the sequence of segments are found in a corpus of segments, and recommending a highest scoring suggestion to complete the sequence of terms.

### TECHNICAL FIELD

The subject matter disclosed herein generally relates to online data entry and, more particularly, to auto-completing user input by expanding a set of terms using textual segments.

### BACKGROUND

Conventionally, users of online databases and systems interface with such using text-based input. Mobile devices, or computing devices with keyboards, are frequently used by users to generate input, request information, search for products or items, and the like.

In order to limit the amount of text that a user enters, some systems attempt to auto-complete input using a wide variety of different algorithms. However, currently available methods fail to effectively auto-complete a user's input.

### BRIEF DESCRIPTION OF THE DRAWINGS

Some embodiments are illustrated by way of example and not limitation in the figures of the accompanying drawings.

FIG. 1 is a block diagram illustrating various components or functional modules of an online social networking service, in an example embodiment.

FIG. 2 is a block diagram illustrating a system for expanding a set of terms using textual segments, according to one example embodiment.

FIG. 3 is a flow chart diagram illustrating a method of expanding a set of terms using textual segments, according to one example embodiment.

FIG. 4 is a flow chart diagram illustrating another method of expanding a set of terms using textual segments, according to one example embodiment.

FIG. 5 is a flow chart diagram illustrating a method of expanding a set of terms using textual segments, according to one example embodiment,

FIG. 6 is a block diagram illustrating components of a machine, according to some example embodiments, able to read instructions from a machine-readable medium (e.g., a machine-readable storage medium) and perform any one or more of the methodologies discussed herein

### DETAILED DESCRIPTION

The description that follows includes systems, methods, techniques, instruction sequences, and computing machine program products that embody the inventive subject matter. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Example methods and systems are directed to auto-completing user input by expanding a set of terms using textual segments. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In one example embodiment, a system receives a set of terms. The set of terms may be complete or incomplete. In one example, the set of terms includes one term: “softwa.” In this example, many previously implemented systems could auto-complete “softwa” to “software.” However, as will be further described, the user may enter many more terms.

In one example embodiment, the system auto-completes “softwa” to “software engineer,” because “software engineer” is more frequently found in an example corpus of textual segments than other potential completions, such as, but not limited to, “software piracy,” “software application,” or simply “software.” In this way, the system completes a user's input with additional terms although there may be no current indication, based on the user's current input, of what those additional terms may be.

In certain embodiments, a corpus of textual segments is generated by parsing user input at an online social networking service. As users search for employment positions, post comments, transmit messages, or otherwise interact with the online social networking service, the system collects the user's input and parses the input, resulting in textual segments. In one example, a user's input includes “software engineering positions in Silicon Valley.” The system may then generate a corpus of textual segments by including each continuous term or set of terms in the corpus.

For example, each of the following textual segments are included in the corpus: “software,” “software engineer,” “software engineer in,” “software engineer in Silicon,” and “software engineer in Silicon Valley.” The system processes input from hundreds, thousands, or millions of users of the online social networking service, and the resulting corpus of textual segments provides a statistical frequency of terms and how they are used.

After a corpus of textual segments is generated, the system may receive input from an additional user. As the user begins entering text-based input, the system then auto-completes the user's input using textual segments found in the corpus of textual segments at a highest frequency. In one example, the user's input includes “autom,” and the textual segment in the corpus of textual segments that is most frequently found is “automobile dealership.” In this example embodiment, the system can auto-complete “autom” to “automobile dealership.” This is the case even though the input from the user did not indicate the term “dealership” in any way.

In one example embodiment, the corpus of textual segments is generated by tokenizing the user input into categories. In one example, a user's input includes “Google software engineer,” and the system identifies “google” as a company and “software engineer” as a position title. In this example, the system includes the “company” category for “google” and the “position title” category for “software engineer.” By including categories for certain textual segments, the corpus of textual segments includes additional information that can be used to auto-complete a user's input, as will be further described. In an additional embodiment, the corpus of textual segments includes a frequency (e.g., a reception count) of each textual segment.

In one example embodiment, the system scores each textual segment by building unigram, bigram, segment, and segmented-bigram statistics from the corpus (e.g., the individual and co-occurrence frequencies of each unigram and each segment) as one skilled in the art may appreciate. In this way, the system can easily determine a frequency of a certain textual segment as well as a frequency of a combination of textual segments, as will be further described.

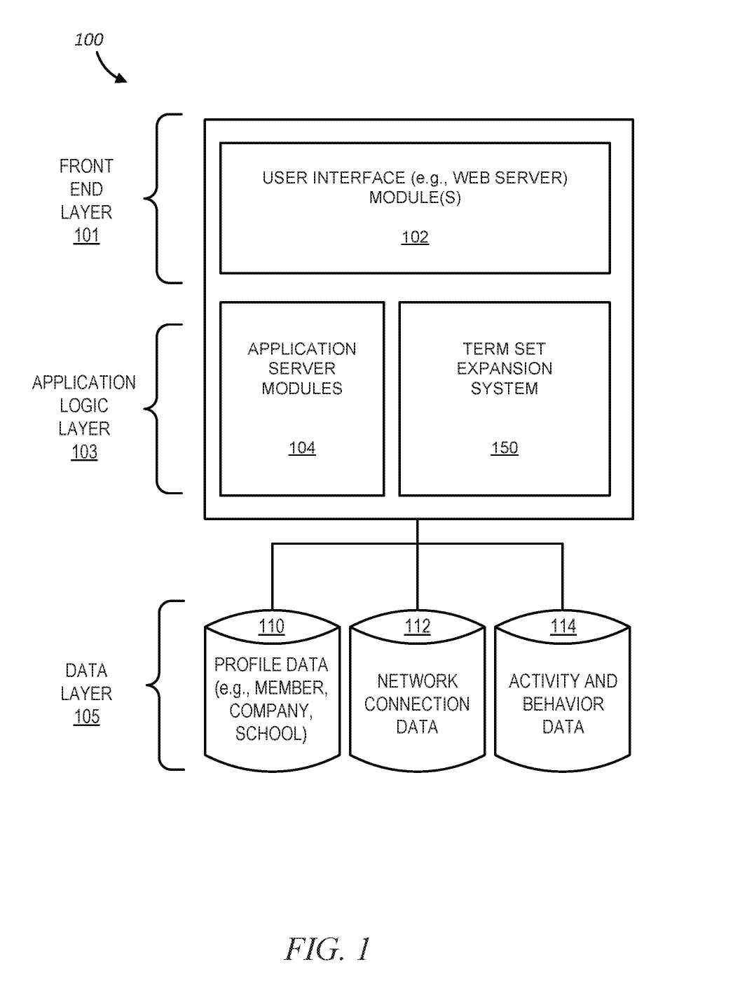

FIG. 1 is a block diagram illustrating various components or functional modules of an online social networking service 100, in an example embodiment. The online social networking service 100 auto-completes one or more terms received from a user. In one example, the online social networking service 100 includes a term set expansion system 150 that performs many of the operations described herein.

A front end layer 101 consists of one or more user interface modules (e.g., a web server) 102, which receive requests from various client computing devices and communicate appropriate responses to the requesting client devices. For example, the user interface module(s) 102 may receive requests in the form of Hypertext Transfer Protocol (HTTP) requests, or other web-based, application programming interface (API) requests. In another example, the front end layer 101 receives requests from an application executing via a member's mobile computing device. In one example embodiment, the user interface module(s) 102 stores user input received by the online social networking service 100.

An application logic layer 103 includes various application server modules 104, which, in conjunction with the user interface module(s) 102, may generate various user interfaces (e.g., web pages, applications, etc.) with data retrieved from various data sources in a data layer 105. In one example embodiment, the application logic layer 103 includes the term set expansion system 150, which receives terms from a user, receives suggestions for an incomplete term, converts the suggestions to respective sequences of textual segments, and retrieves scores for each sequence of textual segments. The term set expansion system 150 them recommends a highest scoring suggestion as a completion of the user's textual input.

In some examples, individual application server modules 104 may be used to implement the functionality associated with various services and features of the online social networking service 100. For instance, the ability of an organization to establish a presence in the social graph of the online social networking service 100, including the ability to establish a customized web page on behalf of an organization, and to publish messages or status updates on behalf of an organization, may be services implemented in independent application server modules 104. Similarly, a variety of other applications or services that are made available to members of the online social networking service 100 may be embodied in their own application server modules 104. Alternatively, various applications may be embodied in a single application server module 104.

As illustrated, the data layer 105 includes, but is not necessarily limited to, several databases 110, 112, 114, such as a database 110 for storing profile data, including both member profile data and profile data for various organizations. In certain examples, the user interface modules 102 are configured to monitor network connections between members of the online social networking service 100 and store the connections in the network connection data database 112. In another example embodiment, the user interface modules 102 are configured to monitor and store member interactions with the online social networking service 100 and store member engagement in the activity and behavior data database 114. In one example embodiment, the term set expansion system 150 retrieves network connection data from the database 112 and member interaction data from the database 114.

Consistent with some examples, when a person initially registers to become a member of the online social networking service 100, the person may be prompted to provide some personal information, such as his or her name, age (e.g., birthdate), gender, sexual orientation, interests, hobbies, contact information, home town, address, spouse's and/or family members' names, educational background (e.g., schools, majors, matriculation and/or graduation dates, etc.), occupation, employment history, skills, religion, professional organizations, and other properties and/or characteristics of the member. This information is stored, for example, in the database 110. Similarly, when a representative of an organization initially registers the organization with the online social networking service 100, the representative may be prompted to provide certain information about the organization. This information may be stored, for example, in the database 110, or another database (not shown).

The online social networking service 100 may provide a broad range of other applications and services that allow members the opportunity to share and receive information, often customized to the interests of the member. For example, in some examples, the online social networking service 100 may include a message sharing application that allows members to upload and share messages with other members. In some examples, members may be able to self-organize into groups, or interest groups, organized around subject matter or a topic of interest. In some examples, the online social networking service 100 may host various job listings providing details of job openings within various organizations.

As members interact with the various applications, services, and content made available via the online social networking service 100, information concerning content items interacted with, such as by viewing, playing, and the like, may be monitored, and information concerning the interactions may be stored, for example, as indicated in FIG. 1 by the database 114. In one example embodiment, the interactions are in response to receiving a message requesting the interactions.

Although not shown, in some examples, the online social networking service 100 provides an API module via which third-party applications can access various services and data provided by the online social networking service 100. For example, using an API, a third-party application may provide a user interface and logic that enables the member to submit and/or configure a set of rules used by the term set expansion system 150. Such third-party applications may be browser-based applications, or may be operating system specific. In particular, some third-party applications may reside and execute on one or more mobile devices (e.g., phones or tablet computing devices) having a mobile operating system.

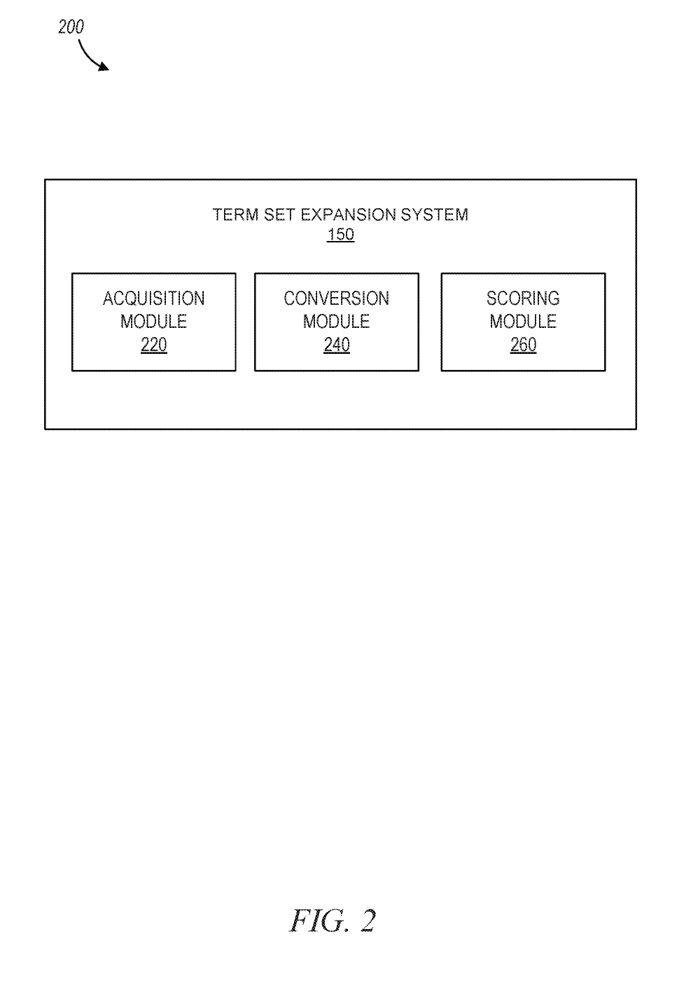

FIG. 2 is a block diagram illustrating a system 200 for expanding a set of terms using textual segments, according to one example embodiment. In this example embodiment, the system 200 includes an acquisition module 220, a conversion module 240, and a scoring module 260.

In one example embodiment, the acquisition module 220 generates a corpus of segments by ingesting raw queries into a table of queries. In this example embodiment each entry in the table includes the terms of the respective queries and a frequency (e.g., a count of how many times the separate segments were received). In one example embodiment the raw queries are queries submitted to a database. For example, as users search for one or more products available via the online social networking service 100, the acquisition module 220 parses the queries into the table as described. In this way, over time, the acquisition module 220 generates a large table of textual segments including their respective frequency of use. In another example embodiment, the acquisition module 220 includes a row in the table for each sequence of segments.

In one example embodiment, the acquisition module 220 is configured to receive user input comprising an incomplete sequence of terms. For example, as the user is entering input and before the user has completed a certain term, the acquisition module 220 processes the complete terms and the incomplete terms. By processing user input before the user has completed the input, the term set expansion system 150 can recommend one or more terms that complete the user input before the user types them.

In another example embodiment, the acquisition module 220 retrieves two or more suggestions to expand the sequence of terms. In one example embodiment, the acquisition module 220 queries a remote database of terms to acquire a set of terms that could complete an incomplete term. In one example, the user enters “sof” and the acquisition module 220 retrieves a set of terms that begin with “sof.” As will be further described, the term set expansion system 150 then scores each of the term suggestions and recommends a highest scoring suggestion.

In one example embodiment, a user enters “google software engineer ne” and the acquisition module 220 retrieves completions of the incomplete term “ne.” In one example, the term is incomplete because the user is currently entering the term and it currently does not match any known term (e.g., in a corpus of terms) in another example embodiment, the acquisition module 220 also retrieves completions of “engineer ne,” and “software engineer ne,” and “google software engineer ne” from a corpus of textual segments. For a variety of reasons and as will he further described, a completion of “google software engineer New York” will score higher than a completion of “goggle software engineer network.” Accordingly, the term set expansion system 150 recommends “google software engineer New York” as a completion to “google software engineer ne.”

In another example embodiment, the conversion module 240 is configured to convert, for each of the suggestions, the sequence of terms to a respective sequence of segments using the suggestion, wherein at least one of the segments comprises two or more terms in the sequence of terms. In this example embodiment, the term set expansion system 150 attempts to expand a single incomplete term to multiple complete terms.

In another example embodiment, in response to not finding a sequence of segments in a corpus of segments, the conversion module 240 converts the sequence of segments to a sequence of terms and scores each sequence of terms using bigram analysis and according to a frequency of how the sequence of terms are found in a corpus of terms. For example, in response to user input including “google software engineer ne,” as previously described, one of the suggestions includes term completions of “ne.” As such, completion suggestions may include, “next,” network,” “nephew,” etc. In response to one suggestion resulting in the segment including“google software engineer nephew” not being found in a corpus of segments (e.g., no user had ever searched for “google software engineer nephew”) the conversion module 240 converts the segment into individual terms and scores the suggestion accordingly. As described herein, a textual segment that includes “google” and “nephew” will likely score very low as compared with other suggestions because the probability of “google” and “nephew” being found in a textual segment is very low. (e.g., the probability of “google” multiplied by the probability of “nephew” is low as compared with other suggestions)

In one example embodiment, the scoring module 260 is configured to score the suggestions according to a frequency of the sequence of segments being found in a corpus of segments and recommend a highest scoring suggestion to complete the sequence of terms provided by the user.

In another example embodiment, the scoring module 260 determines a probability of finding the suggestion in a corpus of segments. In this example embodiment, the probability is the probability of seeing the completion of the sequence of terms in a corpus of queries. In one example embodiment, and as one skilled in the art may appreciate, the conversion module 240 uses a segmented-bigram model to calculate the probability. In one example, the scoring module 260 multiplies the probability of each term in a corpus of terms resulting in a combined probability for the suggestion. In this example, the probability indicates a probability that the suggested expansion is what the user intended.

In one example, the user inputs “software engineer go,” and the acquisition module 220 retrieves suggestions including “software engineer google,” “software engineer goku,” and “software engineer gopro.” In a practical scenario hundreds or thousands of suggestions may be retrieved; however, for the purposes of illustration, three suggestions are discussed.

The first suggestion includes “software engineer google,” and the scoring module 260 multiplies the probability of “google” multiplied by the probability of “engineer” multiplied by the probability of “software.” These three probabilities are multiplied together resulting in a single score for the “goggle” suggestion.

The second suggestion includes “software engineer goku,” and the scoring module 260 multiplies the probability of “goku” multiplied by the probability of “engineer” multiplied by the probability of “software.” These three probabilities are multiplied together resulting in a single score for the “goku” suggestion.

The third suggestion includes “software engineer gopro,” and the scoring module 260 multiplies the probability of “gopro” multiplied by the probability of “engineer” multiplied by the probability of “software.” These three probabilities are multiplied together resulting in a single score for the “gopro” suggestion.

In another example embodiment, the scoring module 260 increases a score for a suggestion in response to the categories for the sequence of segments matching a predefined set of categories.

In one example of categories, the user inputs “google so,” and the acquisition module 220 retrieves suggestions including “google software engineer” and “google software.” In a practical scenario, hundreds or thousands of suggestions may be retrieved; however, for the purposes of illustration, two suggestions are discussed.

The first suggestion includes “google software engineer,” and the scoring module 260 further identifies “google” as a company and “software engineer” as a title. In one example, the scoring module 260 looks up textual segments in a database of things wherein each record is a thing and a category of the thing. Categories for this first suggestion result in a company and a title. In response to the company/title pair being a predefined set of categories, the scoring module 260 increases a score for the suggestion. For example, the scoring module 260 may increase the probability score for the suggestion by 10% or more. Of course, other values may be used and this disclosure is not limited in this regard.

The second suggestion includes “google software,” and the scoring module 260 multiplies the probability of “google” multiplied by the probability of “software.” These two probabilities are multiplied together resulting in a single score for the “software” suggestion. The scoring module 260 then identifies “google” as a company and “software” as a thing. In response to “company” and “thing” not being a predefined pair of categories, the scoring module 260 decreases a score for the suggestion. In one example, the scoring module 260 reduces the probability for the suggestion by 50%. In this way, the scoring module 260 penalizes suggestions that do not match a predefined set of categories. Of course, other values may be used and this disclosure is not limited in this regard.

In one example embodiment, a suggestion results in two textual segments that belong in the same category. In this example, the scoring module 260 disqualifies the suggestion because the term set expansion system 150 assumes that a user does not intent to enter input comprising two segments that belong to the same category.

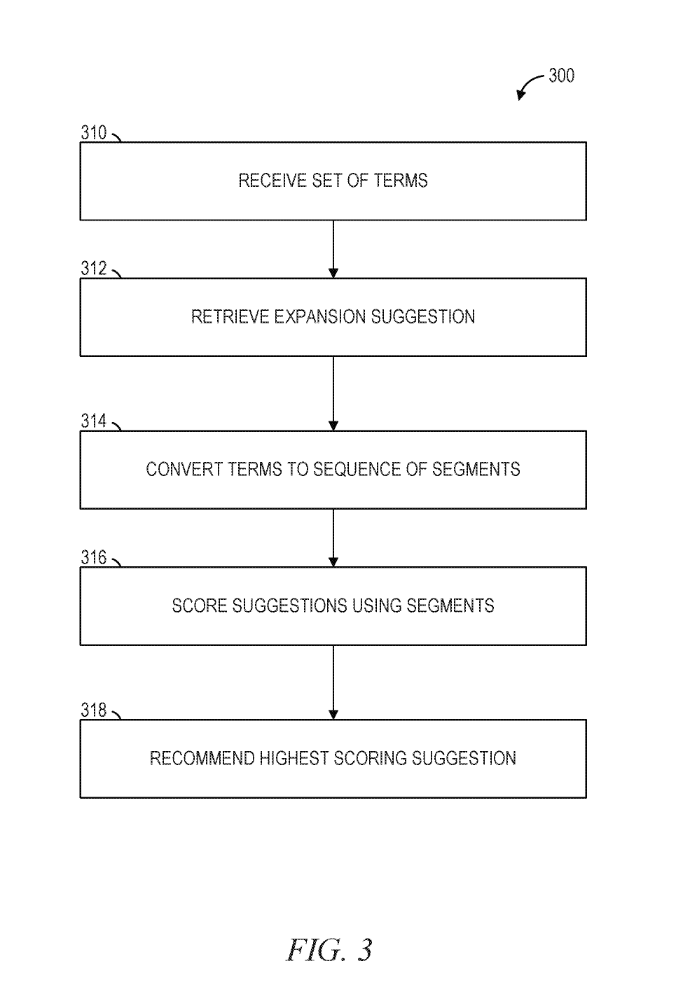

FIG. 3 is a flow chart diagram illustrating a method 300 of expanding a set of terms using textual segments, according to one example embodiment. Operations in the method 300 be performed by the term set expansion system 150 using any of the modules described in FIG. 2.

In one example embodiment, the method 300 begins at operation 310 and the acquisition module 220 receives user input that includes an incomplete sequence of terms. The method 300 continues at operation 312 and the acquisition module 220 retrieves two or more suggestions that expand the incomplete sequence of terms. In one example embodiment, the acquisition module 220 transmits the sequence of terms to a remote system configured to generate completion suggestions according to previously known techniques. The acquisition module 220 may retrieve suggestions either locally or by communicating with a remote system.

The method 300 continues at operation 314 and the conversion module 240 converts the retrieved sequence of terms to a sequence of segments. In one example embodiment, the conversion module 240 looks up each contiguous set of terms in a database of textual segments. The method 300 continues at operation 316 and the scoring module 260 scores each suggestion according to how frequently the resulting sequence of segments is found in a corpus of segments. The method 300 continues at operation 318 and the scoring module 260 recommends a highest scoring suggestion to complete the sequence of terms.

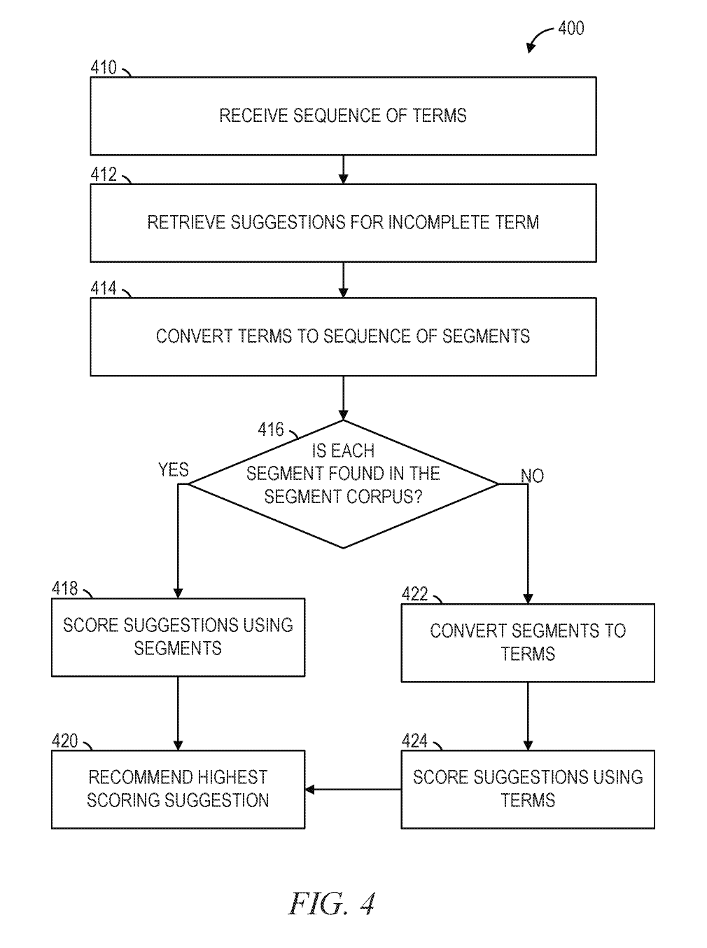

FIG. 4 is a flow chart diagram illustrating another method 400 of expanding a set of terms using textual segments, according to one example embodiment. Operations in the method 400 be performed by the term set expansion system 150 using any of the modules described in FIG. 2.

In one example embodiment, the method 400 begins and at operation 410 the acquisition module 220 receives user input that includes an incomplete sequence of terms. In one example, the acquisition module 220 may process the user input concurrently with the user entering the input. In this example, the term set expansion system 150 may recommend additional terms while the user is typing them.

The method 400 continues at operation 412 and the acquisition module 220 retrieves two or more suggestions that expand the incomplete sequence of terms. In one example the suggestions include additional terms while in other examples the suggestions include completion of a single incomplete term.

The method 400 continues at operation 414 and the conversion module 240 converts each received sequence of terms to a sequence of segments by looking up each contiguous pair of terms in a corpus of textual segments. In one example, the conversion module 240 converts each sequential pair of terms, then each sequence of three terms, etc., until each term in the sequence of terms in converted to a single textual segment. The sequence of segments includes each single term, each pair of terms, and each sequence of three terms, as described. In response to the textual segments being found in the corpus, the conversion module 240 replaces the distinct terms in the sequence of terms with the textual segment.

The method 400 continues at operation 416 and the scoring module 260 determines whether each segment is found in the corpus of segments. In response to no segments being found in the corpus of segments, the scoring module 260 continues at operation 422 and converts each textual segment to individual terms by tokenizing the sequence of segments. The method 400 then continues at operation 424 and the scoring module 260 scores each suggestion using the distinct individual terms. The method 400 then continues at operation 420.

In response to each textual segment in the sequence of segments, at operation 416, being found in the corpus of textual segments, the method 400 continues at operation 418 and the scoring module 260 scores the sequence of segments as described herein. The method 400 continues at operation 420 and the scoring module 260 recommends a highest scoring suggestion to complete the incomplete sequence of terms.

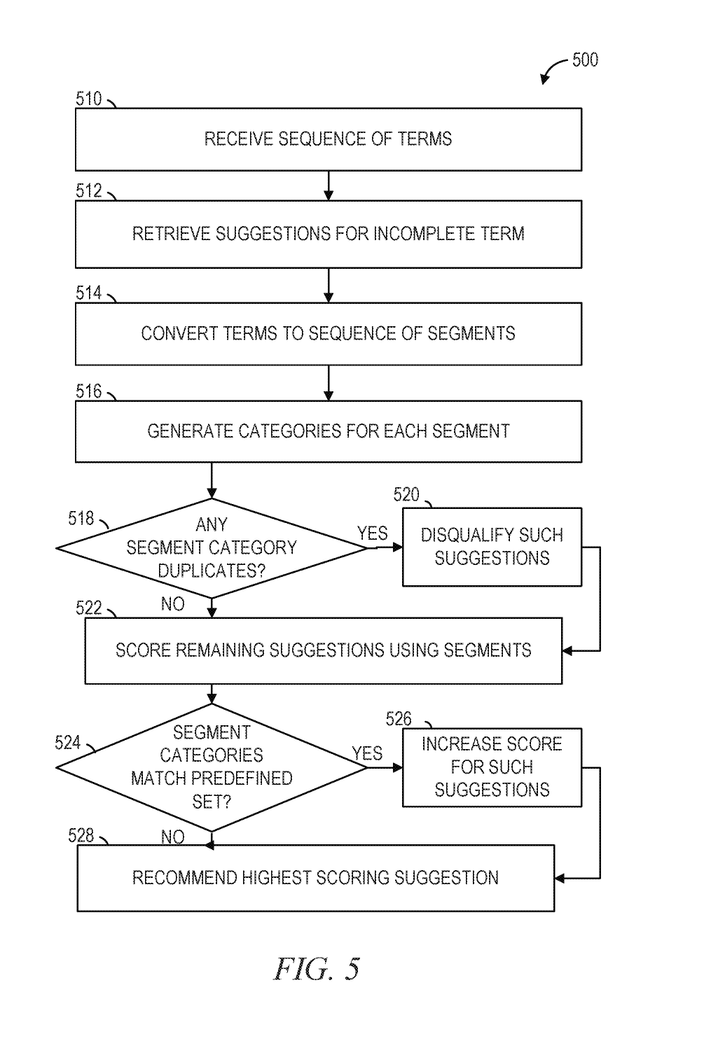

FIG. 5 is a flow chart diagram illustrating a method 500 of expanding a set of terms using textual segments, according to one example embodiment. Operations in the method 500 be performed by the term set expansion system 150 using any of the modules described in FIG. 2.

In one example embodiment, the method 500 begins at operation 510 and the acquisition module 220 receives user input that includes an incomplete sequence of terms. The method 500 continues at operation 512 and the acquisition module 220 retrieves suggestions that expand the incomplete sequence of terms.

The method 500 continues at operation 514 and the conversion module 240 converts the sequence of terms for each suggestion to a sequence of segments for each suggestion. As described herein, although a term may include only one word, a segment may include many words. The method 500 continues at operation 516 and the scoring module 260 determines a category for each segment in each suggestion.

The method 500 continues at operation 518 and the scoring module 260 determines, for each suggestion, whether there are multiple segments that belong to the same category. In response to more than one segment belonging to the same category, the method 500 continues at operation 520 and the scoring module 260 disqualifies the suggestion. In one example, the scoring module 260 sets a score for the suggestion to zero. In response to no segments belonging to the same category, the method 500 continues at operation 522 with the scoring module 260 scoring each suggestion using the textual segments.

The method 500 continues at operation 524 and the scoring module 260 determines whether categories for a certain suggestion match a predefined set of categories. In response to a suggestion including categories that match a predefined set of categories, the method 500 continues at operation 526 and the scoring module 260 increases a score for the suggestion and continues at operation 528. In response to the categories for a suggestion not matching any predefined set of categories, the method 500 continues at operation 528 with the scoring module 260 recommending a highest scoring suggestion to complete the incomplete sequence of terms.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications, and so forth described in conjunction with FIGS. 1-5 are implemented in some embodiments in the context of a machine and an associated software architecture. The sections below describe a representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

### Example Machine Architecture and Machine-Readable Medium

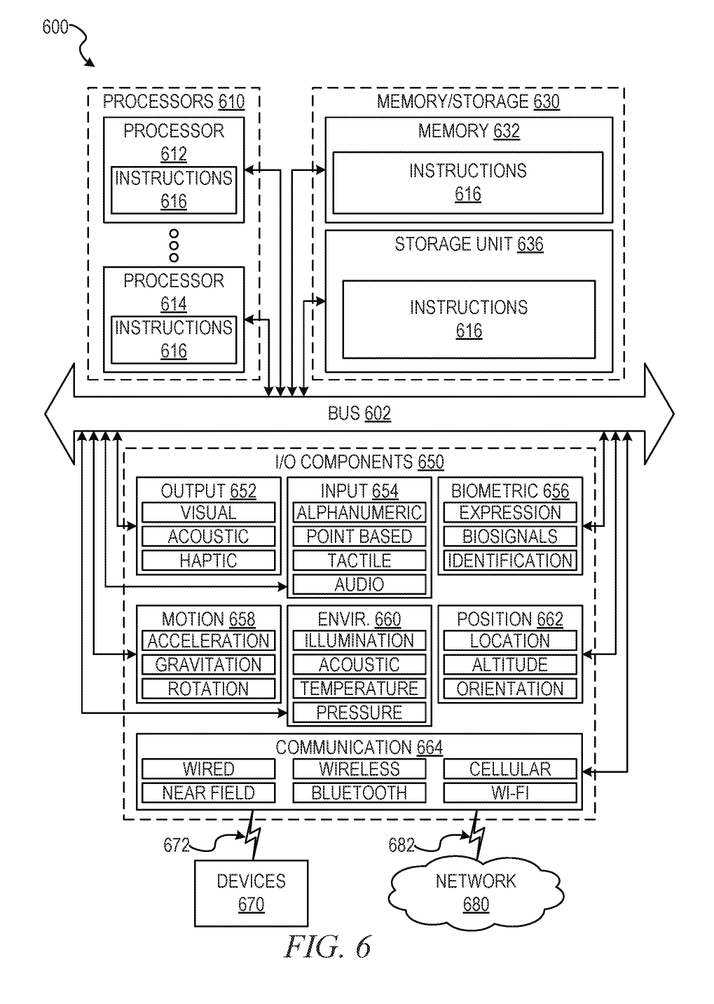

FIG. 6 is a block diagram illustrating components of a machine, according to some example embodiments, able to read instructions from a machine-readable medium (e.g., a machine-readable storage medium) and perform any one or more of the methodologies discussed herein

Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. For example the instructions 616 may cause the machine 600 to execute the flow diagrams of FIGS. 3-5. Additionally, or alternatively, the instructions 616 may implement one or more of the components of FIG. 2. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a personal digital assistant (PDA), or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

The machine 600 may include processors 610, memory/storage 630, and I/O components 650, which may be configured to communicate with each other such as via a bus 602. In an example embodiment, the processors 610 (e.g., a Central Processing Unit (CPU), a Reduced instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 612 and a processor 614 that may execute the instructions 616. The term “processor” is intended to include multi-core processors 610 that may comprise two or more independent processors 612, 614 (sometimes referred to as “cores”) that may execute instructions 616 contemporaneously. Although FIG. 6 shows multiple processors 610, the machine 600 may include a single processor with a single core, a single processor with multiple cores (e.g., a multi-core processor), multiple processors with a single core, multiple processors with multiples cores, or any combination thereof.

The memory/storage 630 may include a memory 632, such as a main memory, or other memory storage, and a storage unit 636, both accessible to the processors 610 such as via the bus 602. The storage unit 636 and memory 632 store the instructions 616 embodying any one or more of the methodologies or functions described herein. The instructions 616 may also reside, completely or partially, within the memory 632, within the storage unit 636, within at least one of the processors 610 (e.g., within the processor's cache memory), or any suitable combination thereof, during execution thereof by the machine 600. Accordingly, the memory 632, the storage unit 636, and the memory of the processors 610 are examples of machine-readable media.

As used herein, “machine-readable medium” means a device able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 616. The term “machine-readable medium” shall also be taken to include any medium, or combination of multiple media, that is capable of storing instructions (e.g., instructions 616) for execution by a machine (e.g., machine 600), such that the instructions, when executed by one or more processors of the machine 600 (e.g., processors 610), cause the machine 600 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 650 may include a wide variety of components to receive input, provide output, produce output, transmit information, exchange information, capture measurements, and so on. The specific I/O components 650 that are included in a particular machine 600 will depend on the type of machine. For example, portable machines such as mobile phones will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion and the grouping is in no way limiting. In various example embodiments, the I/O components 650 may include output components 652 and input components 654. The output components 652 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662 among a wide array of other components. For example, the biometric components 656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 662 may include location sensor components (e.g., a Global Position System (GPS) receiver component), altitude sensor components (e.g., altimeters or barometers that detect air pressure from which altitude may be derived), orientation sensor components (e.g., magnetometers and the like.

Communication may be implemented using a wide variety of technologies. The I/O components 650 may include communication components 664 operable to couple the machine 600 to a network 680 or devices 670 via coupling 682 and coupling 672 respectively. For example, the communication components 664 may include a network interface component or other suitable device to interface with the network 680. In further examples, the communication components 664 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., a peripheral device coupled via a Universal Serial Bus (USB)).

Moreover, the communication components 664 may detect identifiers or include components operable to detect identifiers. For example, the communication components 664 may include Radio Frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 680 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 680 or a portion of the network 680 may include a wireless or cellular network and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third. Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 616 may be transmitted or received over the network 680 using a transmission medium via a network interface device (e.g., a network interface component included in the communication components 664) and utilizing any one of a number of well-known transfer protocols (e.g., HTTP). Similarly, the instructions 616 may be transmitted or received using a transmission medium via the coupling 672 (e.g., a peer-to-peer coupling) to the devices 670. The term “transmission medium” shall be taken to include any intangible medium that is capable of storing, encoding, or carrying the instructions 616 for execution by the machine 600, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may he made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system comprising:
a machine-readable medium having instructions stored thereon, which, when executed by a processor, performs operations comprising:
receiving user input comprising a sequence of terms;
retrieving two or more suggestions to expand the sequence of terms;
converting, for each of the suggestions_{;} the sequence of terms to a respective sequence of segments using each suggestion, wherein at least one of the segments comprises two or more terms in the sequence of terms;
scoring the suggestions according to a frequency of the respective segments being found in a corpus of segments; and
recommending a highest scoring suggestion to expand the sequence of terms.

2. The system of claim 1, wherein the operations further comprise, for each respective sequence of segments and in response to not finding one or more segments in the respective sequence of segments in the corpus, converting the sequence of segments to a second sequence of terms and scoring each sequence of terms using bigram analysis and according to a frequency of how the sequence of terms are found in a corpus of terms.

3. The system of claim 1, wherein the operations further comprise determining a category for each segment in the respective sequence of segments.

4. The system of claim 3, wherein the operations further comprise disqualifying a suggestion in response to two or more segments in the respective sequence of segments belonging to the same category.

5. The system of claim 1, wherein the corpus of segments comprises successfully completed queries at a database.

6. The system of claim 1, where the operations further comprise generating the corpus of segments by tokenizing raw queries into a table of queries, each entry in the table comprising a sequence of segments and a frequency.

7. The system of claim 1, wherein the operations further comprise increasing a score for a suggestion in response to the categories for the sequence of segments matching a predefined set of categories.

8. A method comprising:
receiving user input comprising a sequence of terms;
retrieving two or more suggestions to expand the sequence of terms;
converting, for each of the suggestions, the sequence of terms to a respective sequence of segments using each suggestion, wherein at least one of the segments comprises two or more terms in the sequence of terms;
scoring the suggestions according to a frequency of how the segments are found in a corpus of segments; and
recommending a highest scoring suggestion to expand the sequence of terms.

9. The method of claim 8, further comprising, for each of the respective sequences of segments and in response to not finding one or more segments in the respective sequence of segments in the corpus, converting the sequence of segments to a second sequence of terms and scoring each sequence of terms using a bigram analysis and according to a frequency of how the sequence of terms are found in a corpus of terms.

10. The method of claim 8, further comprising determining a category for each segment in the sequence of segments.

11. The method of claim 10, further comprising disqualifying a suggestion in response to two or more segments in the sequence of segments belonging to the same category.

12. The method of claim 8, wherein the corpus of segments comprises successfully completed queries at a database.

13. The method of claim 8, wherein the corpus of segments is generated by tokenizing raw queries into a table of queries, each entry in the table comprising a sequence of segments and a frequency.

14. The method of claim 8, further comprising increasing a score for a suggestion in response to the categories for the sequence of segments matching a predefined set of categories.

15. A machine-readable hardware medium having instructions stored thereon, which, when executed by a processor, cause the processor to perform:
receiving a sequence of terms;
retrieving two or more suggestions to expand the sequence of terms;
converting, using each of the suggestions, the sequence of terms to a sequence of segments using the suggestion, wherein at least one of the segments comprises two or more terms of the sequence of terms;
scoring the suggestions according to a frequency of how the sequence of segments are found in a corpus of segments; and
recommending a highest scoring suggestion to complete the incomplete term.

16. The machine-readable medium of claim 15, wherein the instructions further cause the processor to, in response to not finding the sequence of segments in the corpus, convert the sequence of segments to a second sequence of terms and scoring each term in the second sequence of terms using a bigram analysis and according to a frequency of how the sequence of terms are found in a corpus of terms.

17. The machine-readable medium of claim 15, wherein the instructions further cause the processor to determine a category for each segment in the sequence of segments.

18. The machine-readable medium of claim 17, wherein the instructions further cause the processor to disqualify a suggestion in response to two or more segments in the sequence of segments belonging to the same category.

19. The machine-readable medium of claim 15, wherein the corpus of segments is generated by tokenizing raw queries into a table of queries, each entry in the table comprising a sequence of segments and a frequency.

20. The machine-readable medium of claim 15, wherein the instructions further cause the processor to increase a score for a suggestion in response to the categories for the corresponding sequence of segments matching a predefined set of categories.
